(19) United States
(12) Patent Application Publication
(10) Pub. No.: US 2022/0281229 A1
(43) Pub. Date: Sep. 8, 2022

(54) THERMAL PRINTERS STORING COLOR CORRECTION DATA

(71) Applicant: Hewlett-Packard Development Company, L.P., Spring, TX (US)

(72) Inventor: Naoto A. Kawamura, Vancouver, WA (US)

(73) Assignee: Hewlett-Packard Development Company, L.P., Spring, TX (US)

(21) Appl. No.: 17/635,046

(22) PCT Filed: Oct. 11, 2019
(86) PCT No.: PCT/US2019/055918

§ 371 Date: Feb. 14, 2022

(51) Int. Cl. B41J 2/36; H04N 1/60

(52) U.S. Cl. CPC B41J 2/36; H04N 1/6097

(57) ABSTRACT

An example thermal printer includes: a receptacle to receive a thermal media sheet; a thermal printhead to heat the thermal media sheet in the receptacle; a memory to store color correction data for types of thermal media sheets; a processor interconnected with the memory and the thermal printhead, the processor to: identify a type of the thermal media sheet in the receptacle; obtain, from the memory, the color correction data for the type of the thermal media sheet; and control the thermal printhead to heat the thermal media sheet based on the color correction data.

### BACKGROUND

Thermal printers print to thermal media sheets by applying heat to the thermal media sheets. The thermal printers may apply the heat with specific temperature and duration parameters to selectively activate certain heat-sensitive layers of the thermal media sheets to obtain desired colors and images.

### BRIEF DESCRIPTION OF THE DRAWINGS

FIG. 1 is a block diagram of an example thermal printer storing color correction data.

FIG. 2 is a block diagram of another example thermal printer storing color correction data.

FIG. 3 is a flowchart of a method of printing using color correction data in a thermal printer.

### DETAILED DESCRIPTION

Thermal printers print by applying heat with specific temperature and duration parameters to selectively activate certain heat-sensitive layers of thermal media sheets to obtain desired colors and images. The heating parameters may vary based on the thickness of the heat-sensitive layers. Accordingly, thermal printers are to be calibrated for each batch of thermal media sheets to account for manufacturing variability in the thickness of the heat-sensitive layers. Thus, to switch between different types of media sheets, such as between a standard size media sheet and a panoramic size media sheet, the printer is recalibrated to obtain corresponding color correction data to allow for corresponding adjustments in the heating parameters.

To obtain correct color correction data, printers may use calibration sheets having barcode data encoded thereon. The barcode data includes information about color correction data to be incorporated during printing for that batch of media. Thus, each calibration media sheet is encoded with its own color correction data.

An example printer includes a receptacle to receive the media sheet, a thermal printhead to heat the media sheet in the receptacle, a memory to store color correction data associated with multiple types of media sheets, and a processor and possibly a sensor to identify the type of media sheet in the receptacle, obtain the appropriate color correction data for the type and batch of media sheet, and control the thermal printhead to heat the media sheet according to the color correction data. The printer may identify the type of media sheet based on mobile data from a mobile device (e.g. operated by a user to identify a regular or panoramic view), based on chip data from a memory chip associated with the media sheet, or based on detection of the size of the media sheet via a sensor, or a code that is printed on the media. The printer may detect the size of the media sheet based on the media sheet itself or based on a cassette holding the media sheet. The printer may include a physical or optical switch to detect the size of the media sheet. Thus, a user may swap, for example, between regular and panoramic media sheets without recalibrating the color correction data stored at the printer.

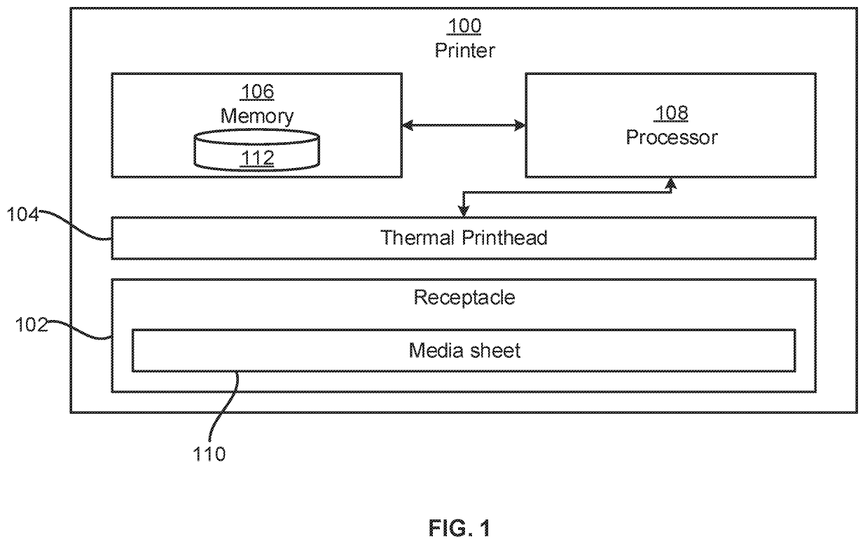

FIG. 1 shows a block diagram of an example printer 100 (also referred to herein as simply printer 100). The printer 100 includes a receptacle 102, a thermal printhead 104, a memory 106 and a processor 108.

In particular, the printer 100 is a thermal printer, such as a zero-ink printer, to print on thermal media sheets 110. The thermal media sheets 110 include heat-sensitive layers which may be selectively activated by the printer 100 based on predefined heating parameters (i.e., temperature and duration of heating) to produce different colors. Accordingly, the printer 100 prints to the media sheets 110 by heating the media sheets 110. The media sheets 110 may have different types, including different color bases (e.g., color, black and white), and different sizes (e.g., standard size, panoramic size, and the like).

The receptacle 102 is to receive one of the media sheets 110 for printing to the media sheet 110. The receptacle 102 may be sized to receive any of the different types of media sheet 110.

The thermal printhead 104 is operatively coupled to the receptacle 102 to heat the media sheet 110 which is in the receptacle 102. Specifically, the thermal printhead 104 may be controlled by the processor 108 to heat the media sheet 110 according to different the heating parameters (i.e., temperatures and durations of heating) to selectively activate the heat-sensitive layers of the media sheet 110 to print to the media sheet 110.

The memory 106 may include a non-transitory machine-readable storage medium that may be electronic, magnetic, optical, or other physical storage device to store color correction data, for example, in a repository 112. In particular, the repository 112 stores an association between a type of media sheet 110 and the color correction data associated with the batch of that type of media sheet. The color correction data may include corrections or adjustments in the heating parameters (i.e., the temperature and duration of heating) for its corresponding type of media sheet to account for manufacturing variability (e.g., in the thickness of the heat-sensitive layers) of different types and different batches of the media sheets 110. The memory 106 further stores machine-readable instructions executable by the processor 108 to realize the functionality described herein.

Accordingly, the processor 108 is interconnected with the memory 106 and the thermal printhead 104. The processor 108 may include a central processing unit (CPU), a microcontroller, a microprocessor, a processing core, or similar device capable of executing instructions.

In particular, the instructions cause the processor 108 to identify the type of thermal media sheet 110 in the receptacle 102, obtain, from the memory 106, and, in particular, the repository 112, the color correction data for the type of thermal media sheet 110, and control the thermal printhead 104 to heat the thermal media sheet 110 based on the color correction data.

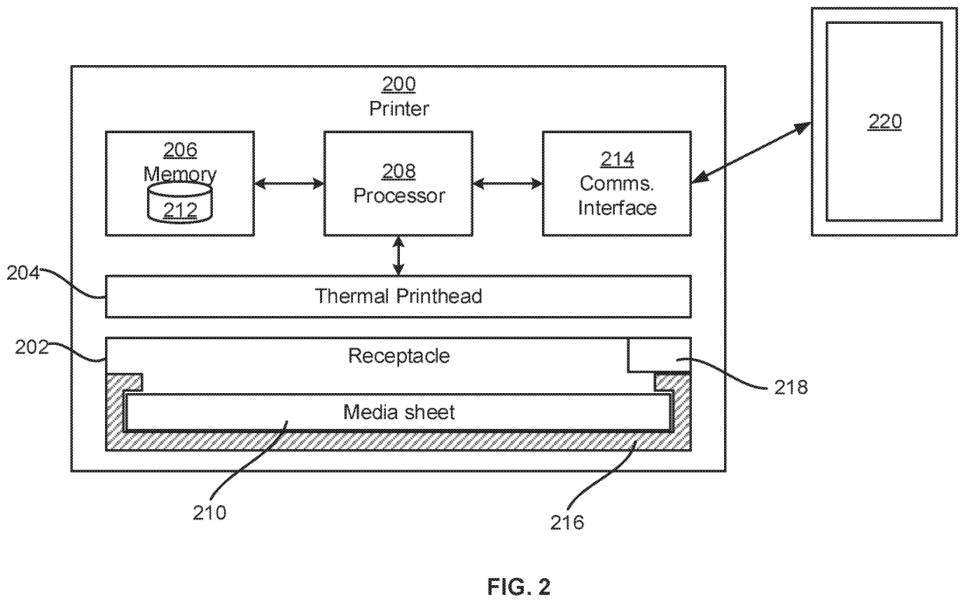

FIG. 2 depicts a block diagram of another example printer 200. The printer 200 includes a receptacle 202, a thermal printhead 204, a memory 206 and a processor 208. The printer 200 further includes a communications interface 214

The receptacle 202 is similar to the receptacle 102. In particular, the receptacle 202 is to receive a thermal media sheet 210 for printing to the media sheet 210. The receptacle 202 may be sized to receive any of the different types of media sheet 210. The receptacle 202 may receive the media sheet 210 directly, for example on a receiving surface of the receptacle 202. In other examples, the receptacle 202 may include a slot 216 to receive the media sheet 210. For example, the media sheet 210 may be supported in a cassette, which is received in the slot 216.

The receptacle 202 may further include a detector 218 to detect the type of the media sheet 210. The detector 218 may be, for example, a physical switch or an optical switch to detect a size of the media sheet 210. For example, the slot 216 may include an integrated physical switch to detect the size of the cassette containing the media sheet 210. In other examples, the detector 218 may be an optical switch to detect the size of the media sheet 210 received directly in the receptacle. In still further examples, the detector 218 may be a chip reader or the like to obtain data stored on a chip of the media sheet 210. For example, the chip reader may be integrated with the slot 216 to read a chip integrated in the media sheet 210 or the cassette containing the media sheet 210.

The thermal printhead 204 is similar to the thermal printhead 104. In particular, the thermal printhead 104 is operatively coupled to the receptacle 202 to heat the media sheet 210 in the receptacle 202. Specifically, the thermal printhead 204 may be controlled by the processor 208 to heat the media sheet 210 according to different heating parameters (i.e., temperatures and durations of heating) to selectively activate the heat-sensitive layers of the media sheet 210 to print to the media sheet 210.

The memory 206 is similar to the memory 106. In particular, the memory 206 may include a non-transitory machine-readable storage medium that may be electronic, magnetic, optical, or other physical storage device to store color correction data, for example, in a repository 212. In particular, the repository 212 stores an association between types of media sheet 210 and the color correction data associated with each respective type of media sheet. For example, the repository 212 may store first color correction data for a first type of media sheet, and second color correction data for a second type of media sheet. In some examples, the type of media sheet 210 may be indexed based on the size of the media sheet 210. The color correction data may include corrections or adjustments in the heating parameters (i.e., the temperature and duration of heating) for its corresponding type of media sheet to account for manufacturing variability (e.g., in the thickness of the heat-sensitive layers) of different types and different batches of the media sheets 210. The memory 206 further stores machine-readable instructions executable by the processor 208 to realize the functionality described herein.

The processor 208 is interconnected with the memory 206 and the thermal printhead 204. The processor 208 may include a central processing unit (CPU), a microcontroller, a microprocessor, a processing core, or similar device capable of executing instructions. In particular, the instructions cause the processor 208 to identify the type of thermal media sheet 210 in the receptacle 202, obtain, from the memory 206, and, in particular, the repository 212, the color correction data for the type of thermal media sheet 210, and control the thermal printhead 204 to heat the thermal media sheet 210 based on the color correction data. Thus, for example, the processor 208 may identify a first media sheet as being the first type of media sheet and may obtain the first color correction data to apply to the first media sheet. On a subsequent printing operation, the processor 208 may identify a second media sheet as being the second type of media sheet and may obtain the second color correction data to apply to the second media sheet.

The printer 200 further includes the communications interface 214. The communications interface 214 is interconnected with the processor 208 and is to allow the printer 200 to communicate with other computing devices, such as a mobile device 220. Accordingly, the communications interface 214 includes suitable hardware (e.g. transmitters, receivers, network interface controllers and the like) based on the types of links (e.g., wired, wireless, short-range, and the like) that the printer 200 is to communicate over.

The mobile device 220 may be a mobile phone or tablet, or other suitable computing device. Specifically, the mobile device 220 may be in communication with the printer 200 to initiate, control, and provide data to the printer 200 for a printing operation.

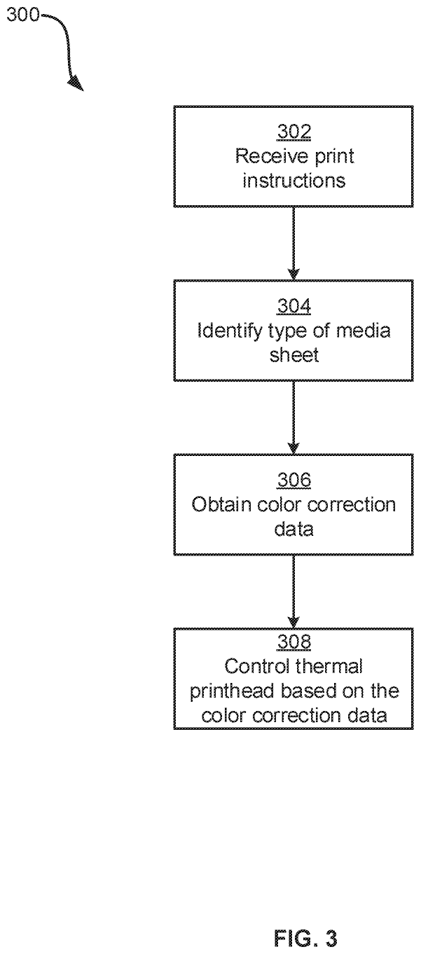

FIG. 3 depicts a flowchart of an example method 300 of printing using color correction data in a thermal printer. In particular, the method 300 may be performed to dynamically apply color correction based on the media sheet in the receptacle of the printer. The method 300 will be described in conjunction with its performance by the printer 200, and in particular, with reference to the components illustrated in FIG. 2. In other examples, the method 300 may be performed by other suitable devices or systems.

The method 300 is initiated at block 302, where the processor 208 receives print instructions. The print instructions may be initiated, for example, from the mobile device 220 via the communications interface 214. In other examples, the print instructions may be received from an input mechanism integrated with the printer 200. Specifically, the print instructions may include print data defining the image to be printed to the media sheet 210.

At block 304, the processor 208 identifies the type of media sheet 210 in the receptacle 202.

In some examples, the processor 208 may identify the type of media sheet 210 based on mobile data received from the mobile device 220. For example, the processor 208 may receive, from the mobile device 220 via the communications interface 214, mobile data identifying the type of the media sheet 210. Specifically, the mobile device 220 may present a user interface to a user of the mobile device 220 to select the type of media sheet 210 in the receptacle. The mobile device 220 may then send the mobile data including the selected type of media sheet to the printer 200, and specifically, to the communications interface 214. For example, the mobile device 220 may send the mobile data identifying the type of media sheet concurrently with the print instructions.

In other examples, rather than receiving a selection from the user identifying the type of media sheet, the type of media sheet may be determined based on the print data received from the mobile device 220. Specifically, the type of media sheet may be determined based on, for example, a size of the image to be printed. For example, images having a length within a threshold percentage of a width of the image may be identified as having a standard size type, while images having a length above the threshold percentage of the width of the image may be identified as being a panoramic size type. The determination based on the print data may be performed at the mobile device 220 or at the processor 208.

In still further examples, the processor 208 may identify the type of media sheet 210 in the receptacle 202 based on the media sheet 210 itself. For example, the printer 200 may include a physical switch or an optical switch as the detector 218. Thus, a media sheet 210 having a panoramic size type may trigger the optical or physical switch, while a media sheet having a standard size type may not, or vice versa.

In other examples, the printer 200 may include an integrated chip reader as the detector 218. The chip reader may interface with a memory chip associated with the thermal media sheet to obtain chip data identifying the type of the media sheet 210. The memory chip may be integrated with the media sheet 210 itself or it may be integrated with a cassette supporting the media sheet 210.

At block 306, the processor 208 obtains color correction data based on the type of media sheet identified at block 304. Specifically, the type of media sheet identified at block 304 may serve as an index. Accordingly, the processor 208 may look up and retrieve the corresponding color correction data from the repository 212. In other examples, the processor 208 may request the color correction data from the mobile device 220.

At block 308, the processor 208 controls the thermal printhead 204 to print to the media sheet 210. Specifically, the processor 208 controls the thermal printhead 204 to heat the media sheet 210 based on the print data obtained at block 302 and the color correction data obtained at block 306. More particularly, the processor 208 may adjust the temperature and duration of heating applied by the thermal printhead 204 based on the color correction data to achieve the colors defined in the print data.

As described above, a thermal printer may store color correction data for different types of media sheets. The printer includes a receptacle to receive the media sheet, a thermal printhead to heat the media sheet in the receptacle, a memory to store color correction data for the types of media sheets, and a processor to identify the type of media sheet in the receptacle, obtain the corresponding color correction data for the type of media sheet, and control the thermal printhead to heat the media sheet according to the color correction data. Specifically, the printer may adjust a temperature and a duration of heating applied by the thermal printhead based on the color correction data. Thus, the printer may print to different types of media sheets based on the correct color correction data.

The scope of the claims should not be limited by the above examples, but should be given the broadest interpretation consistent with the description as a whole.

1. A thermal printer comprising:
a receptacle to receive a thermal media sheet;
a thermal printhead to heat the thermal media sheet in the receptacle;
a memory to store color correction data for types of thermal media sheets;
a processor interconnected with the memory and the thermal printhead, the processor to:
identify a type of the thermal media sheet in the receptacle;
obtain, from the memory, the color correction data for the type of the thermal media sheet; and
control the thermal printhead to heat the thermal media sheet based on the color correction data.

2. The thermal printer of claim 1, further comprising a communications interface interconnected with the processor, the communications interface to receive, from a mobile device, mobile data identifying the type of the thermal media sheet.

3. The thermal printer of claim 1, further comprising a chip reader to interface with a memory chip associated with the thermal media sheet to obtain chip data identifying the type of the thermal media sheet.

4. The thermal printer of claim 1, wherein the processor is to identify the type of the thermal media sheet based on a size of the thermal media sheet.

5. The thermal printer of claim 4, wherein the receptacle further comprises a physical switch to detect the size of the thermal media sheet.

6. The thermal printer of claim 4, wherein the receptacle further comprises an optical switch to detect the size of the thermal media sheet.

7. The thermal printer of claim 1, wherein the receptacle further comprises a slot to receive a cassette holding the thermal media sheet.

8. The thermal printer of claim 1, wherein to control the thermal printhead, the processor is to adjust a temperature and a duration of heating applied by the thermal printhead based on the color correction data.

9. A method in a thermal printer, the method comprising:
identifying a type of a thermal media sheet in a receptacle of the thermal printer;
obtaining, from a memory of the thermal printer, color correction data for the type of the thermal media sheet; and
controlling a thermal printhead of the thermal printer to heat the thermal media sheet based on the color correction data.

10. The method of claim 9, wherein identifying the type of the thermal media sheet comprises receiving mobile data identifying the type of the thermal media sheet.

11. The method of claim 9, wherein identifying the type of the thermal media sheet comprises obtaining chip data identifying the type of the thermal media sheet.

12. The method of claim 9, wherein identifying the type of the thermal media sheet comprises identifying a size of the thermal media sheet.

13. A thermal printer comprising:
a receptacle to receive a thermal media sheet;
a thermal printhead to heat the thermal media sheet in the receptacle;
a memory to store color correction data for types of thermal media sheets;
a communications interface to receive print data;
a processor interconnected with the memory, the communications interface and the thermal printhead, the processor to:
identify a type of the thermal media sheet in the receptacle;
obtain, from the memory, the color correction data for the type of the thermal media sheet; and
control the thermal printhead to print to the thermal media sheet based on the print data; and
adjust a temperature and a duration of heating applied by the thermal printhead based on the color correction data.

14. The thermal printer of claim 13, wherein the processor is to determine the type of the thermal media sheet based on the print data.

15. The thermal printer of claim 13, wherein the communications interface is to receive, from a mobile device, mobile data identifying the type of the thermal media sheet.
